(19) United States
(12) Patent Application Publication
(10) Pub. No.: US 2007/0019137 A1
(43) Pub. Date: Jan. 25, 2007

(54) Display substrate and liquid crystal display panel having the same

(75) Inventors: Hyun-Young Kim, Suwon-si (KR); Jun-Ho Song, Seongnam-si (KR); Sang-Woo Park, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/485,028

(22) Filed: Jul. 11, 2006

(30) Foreign Application Priority Data
Jul. 11, 2005 (KR) 2005-62021

(51) Int. Cl. G02F 1/1335

(52) U.S. Cl. 349/114

(57) ABSTRACT

A display substrate includes a substrate having an overcoat layer. The substrate includes a plurality of pixel units. Each of the pixel units has a transmissive portion through which light passes and a reflective portion from which light is reflected. The overcoat layer has an opening between adjacent pixel elements. The overcoat layer is positioned to correspond to the location of the reflective portions. Therefore, liquid crystals are easily added to an LCD panel which includes the substrate.

### CROSS REFERENCE OF RELATED APPLICATION

The present application claims priority from Korean Patent Application No. 2005-62021, filed on Jul. 11, 2005, the disclosure of which is hereby incorporated herein by reference in its entirety.

### BACKGROUND OF THE INVENTION

1. Field of the Invention

The present invention relates to a display substrate and a liquid crystal display (LCD) panel using the display substrate. More particularly, the present invention relates to a display substrate capable of easily receiving a liquid crystal to simplify manufacturing process and an LCD panel having the display substrate.

2. Description of the Related Art

An LCD panel, in general, includes a lower substrate, an upper substrate and a liquid crystal layer. The upper substrate has an area which is the same as that of the lower substrate. The liquid crystal layer is interposed between the lower and upper substrates. The orientation of liquid crystals of the liquid crystal layer vary as a function of an electric field applied thereto, and thus a light transmittance of the liquid crystal layer is changed to display an image.

LCD panels are classified into a reflective LCD panel, a transmissive LCD panel and reflective-transmissive LCD panels based on the light source. In a reflective LCD panel, an externally provided light is reflected from the LCD panel to display the image. In a transmissive LCD panel, an internally provided light passes through the transmissive LCD panel to display the image. In a reflective-transmissive LCD panel, the image is displayed using the externally provided light in a reflective mode and the internally provided light in a transmissive mode.

When a cell-gap in a reflective-transmissive LCD panel is uniform, a path length of the externally provided light is about two times that of a path length of the internally provided light and accordingly a phase difference of the transmissive mode is different than a phase difference of the reflective mode. This causing reduction in the image display quality. The cell-gap is a thickness of the liquid crystal layer. In order to improve the image display quality of the reflective-transmissive LCD panel, a cell-gap of the reflective mode is different from a cell-gap of the transmissive mode. A dual cell-gap represents the cell-gap of the reflective mode and the cell-gap of the transmissive mode that are different from each other.

The dual cell-gap of the reflective-transmissive LCD panel is formed by an organic layer in a reflective region of the lower substrate or an overcoat layer in a reflective region of the upper substrate.

### SUMMARY OF THE INVENTION

The present invention provides a display substrate capable of easily receiving a liquid crystal to simplify manufacturing process.

The present invention also provides an LCD panel having the above-mentioned display substrate.

A display substrate in accordance with one aspect of the present invention includes a substrate and an overcoat layer. The substrate includes a plurality of pixel parts. Each of the pixel parts has a transmissive portion through which a first light passes and a reflective from which a second light is reflected. The overcoat layer has an opening between adjacent pixel parts. The overcoat layer corresponds to the reflective portions.

A display substrate in accordance with another aspect of the present invention includes a substrate, an organic layer, a pixel electrode and a reflective electrode. The substrate includes a plurality of pixel parts and a switching element. The pixel parts are defined by source and gate lines. The switching element is in each of the pixel parts. The organic layer is in a portion of each of the pixel parts along the gate lines. The organic layer includes a plurality of openings corresponding to a portion of the source lines. The pixel electrode is electrically connected to the switching element. The pixel electrode is in each of the pixel parts and transmitting a first light. The reflective electrode is on the organic layer to define a transmissive portion and a reflective portion in each of the pixel parts. The second light is reflected from the reflective electrode.

A liquid crystal display panel in accordance with one aspect of the present invention includes a first substrate, a second substrate and a liquid crystal layer. The first substrate includes a plurality of source lines, a plurality of gate lines and a plurality of pixel parts. Each of the pixel parts has a transmissive portion and a reflective portion. The second substrate includes an overcoat layer corresponding to the reflective portion. The overcoat layer has a plurality of openings corresponding to a portion of the source lines. The liquid crystal layer is interposed between the first and second substrates. The liquid crystal layer has a first cell-gap corresponding to the transmissive portion and a second cell-gap corresponding to the reflective portion that has the overcoat layer.

A liquid crystal display panel in accordance with another aspect of the present invention includes a display substrate, an insulation layer and a liquid crystal layer. The display substrate includes a display region and a peripheral region. The display region has a plurality of pixel parts that have a transmissive portion and a reflective portion. The peripheral region surrounds the display region. The insulating layer corresponds to the reflective portion and a portion of the peripheral region. The liquid crystal layer has a first cell-gap corresponding to the transmissive portion and a second cell-gap corresponding to the reflective portion that has the insulating layer.

According to the present invention, the insulating layer for forming the dual cell gap includes openings that extend in the injection direction of the liquid crystals so that the liquid crystals can be easily added to the LCD device.

### BRIEF DESCRIPTION OF THE DRAWINGS

The above and other advantages of the present invention will become more apparent in light of the following detailed description of the exemplary embodiments with reference to the accompanying drawings, in which:

FIG. 1 is a plan view showing a reflective-transmissive type of liquid crystal display (LCD) panel in accordance with one embodiment of the present invention;

FIG. 2 is an enlarged plan view showing a portion of the reflective-transmissive LCD panel shown in FIG. 1;

FIG. 3 is a cross-sectional view taken along a line I-I′ shown in FIG. 2;

FIG. 4 is a cross-sectional view taken along a line II-II′ shown in FIG. 2;

FIG. 5 is a cross-sectional view taken along a line III-III′ shown in FIG. 2;

FIG. 6 is a cross-sectional view taken along a line IV-IV′ shown in FIG. 2;

FIGS. 7A to 7C are cross-sectional views showing a method of manufacturing an upper substrate shown in FIGS. 4 and 5;

FIG. 8 is a cross-sectional view showing a reflective-transmissive LCD panel in accordance with another embodiment of the present invention;

FIGS. 9A to 9C are cross-sectional views showing a method of manufacturing a lower substrate shown in FIG. 8;

FIG. 10 is a plan view showing a portion of a reflective-transmissive LCD panel in accordance with another embodiment of the present invention; and

FIG. 11 is a plan view showing a liquid crystal injected into the reflective-transmissive LCD panel shown in FIG. 10.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, and third may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

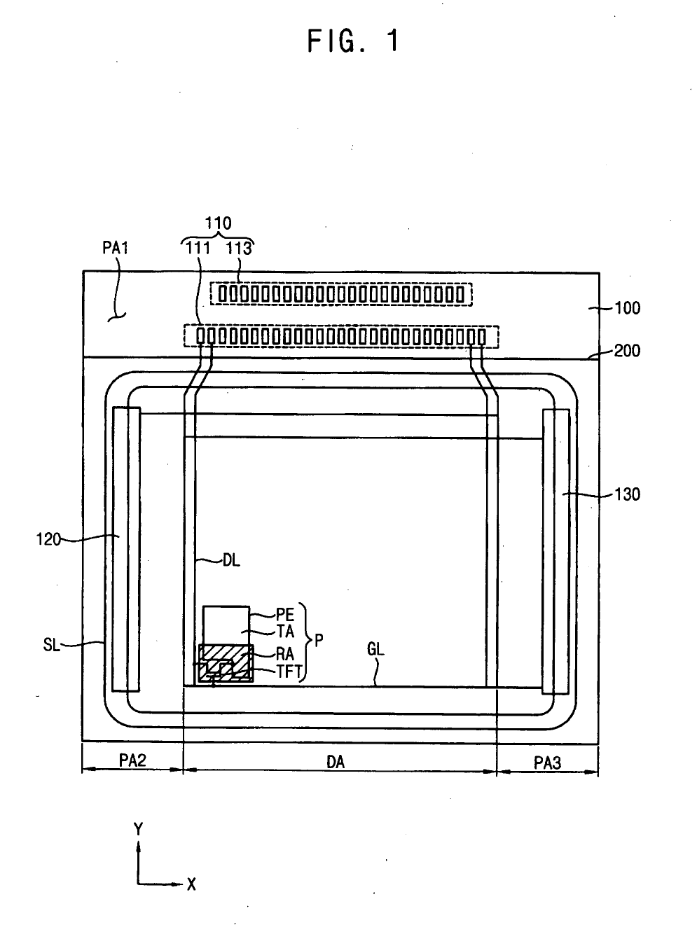

FIG. 1 is a plan view showing a reflective-transmissive liquid crystal display (LCD) panel in accordance with one embodiment of the present invention.

Referring to FIG. 1, the reflective-transmissive LCD panel includes a lower substrate 100, an upper substrate 200 and a liquid crystal layer (not shown) that is interposed between the lower and upper substrates 100 and 200.

The lower substrate 100 includes a display region DA, a first peripheral region PA1, a second peripheral region PA2 and a third peripheral region PA3.

A plurality of source lines DL and a plurality of gate lines GL are formed in the display region DA. The source lines DL are extended in a first direction that is an X-direction. The gate lines GL are extended in a second direction that is a Y-direction. The second direction crosses the first direction.

A plurality of pixel units P are included within areas defined by the source and gate lines DL and GL adjacent to each other in the display region DA. The pixel units P may include a red pixel element, a green pixel element and a blue pixel element. A switching element TFT and a pixel electrode PE are formed in each of the pixel units P. The pixel electrode PE is electrically connected to the switching element TFT.

Each of the pixel unit P includes a reflective region RA and a transmissive region TA. A reflective electrode is formed in the reflective region RA, but not in the transmissive region TA. A first light that is an internally provided light passes through the transmissive region TA. The first light is generated from a rear of the reflective-transmissive LCD panel. A second light that is an externally provided light is reflected from the reflective region RA. The second light is from a front of the reflective-transmissive LCD panel.

Connector 110 which couples to the LCD panel driving signals is formed in the first peripheral region PA1. Connector 110 includes a first pad portion 111 and a second pad portion 113. Driving signals are applied from a flexible printed circuit board to the first pad portion 111. A driving chip is mounted on the second pad part 113. The driving chip applies a data voltage to the source lines DL based on the driving signal.

A first gate circuit 120 is provided in the second peripheral region PA2. The first gate circuit 120 applies gate signals to odd numbered gate lines of the gate lines GL.

A second gate circuit 130 is provided in the third peripheral region PA3. The second gate circuit 130 applies gate signals to even numbered gate lines of the gate lines GL. Alternatively, a gate circuit part (not shown) that applies the gate signals to the entire of the gate lines GL may be formed in the second peripheral region PA2 or the third peripheral region PA3.

A sealing member is formed in a seal line region SL that is in the first, second and third peripheral regions PA1, PA2 and PA3 that surround the display region DA. The lower substrate 100 is combined with the upper substrate 200 through the sealing member.

A color filter layer and a common electrode are formed on the upper substrate 200. The color filter layer is positioned above pixel units P. The color filter layer includes a red color filter pattern, a green color filter pattern and a blue color filter pattern. The common electrode and each of the pixel units P define a liquid crystal capacitor. A common voltage VCOM is applied to the common electrode.

When the sealing member is formed in the seal line region SL to combine the lower substrate 100 to the upper substrate 200, liquid crystals for forming the liquid crystal layer (not shown) are injected into a space between the first and second substrates 100 and 200 and the sealing member in the Y-direction.

The reflective-transmissive LCD panel may include an organic layer on the lower substrate 100 corresponding to the reflective region RA or an overcoat layer on the upper substrate 200 corresponding to the reflective region RA to control a cell-gap of the reflective region RA and a cell-gap of the transmissive region TA.

The organic layer of the lower substrate 100 and the overcoat layer of the upper substrate 200 may be substantially perpendicular to the injection direction of the liquid crystal layer (not shown). In FIG. 1, the injection direction of the liquid crystal layer (not shown) is the Y-direction i.e. in to the page. A plurality of openings may be formed on the organic layer or the overcoat layer. The openings correspond to a portion of the source lines DL. Each of the openings may have a groove shape to accelerate a flow of the liquid crystals of the liquid crystal layer (not shown).

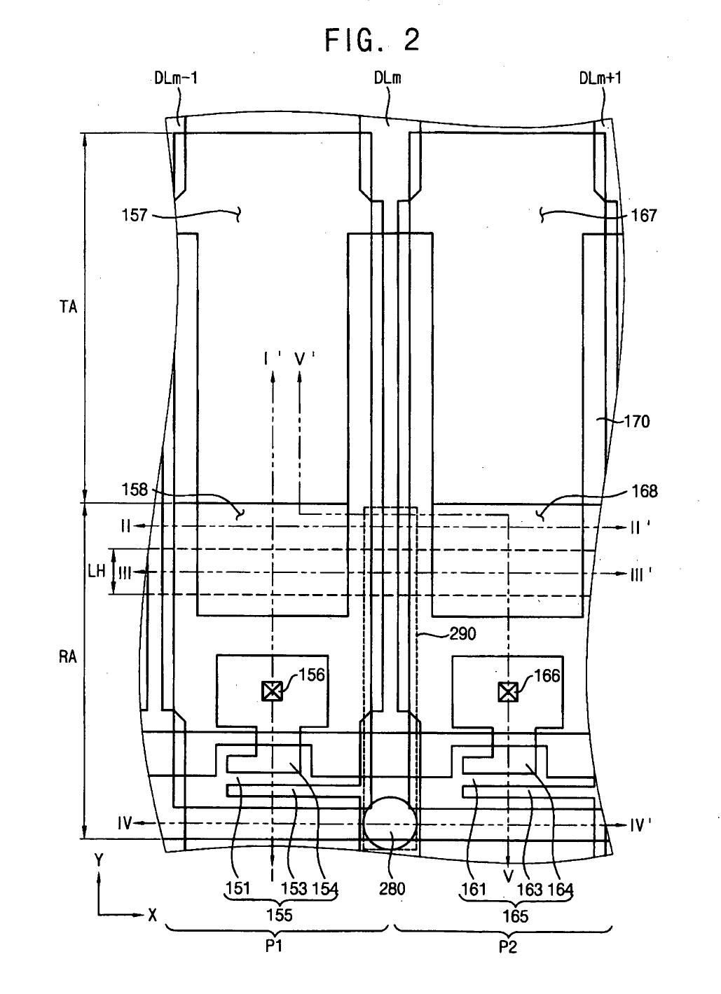

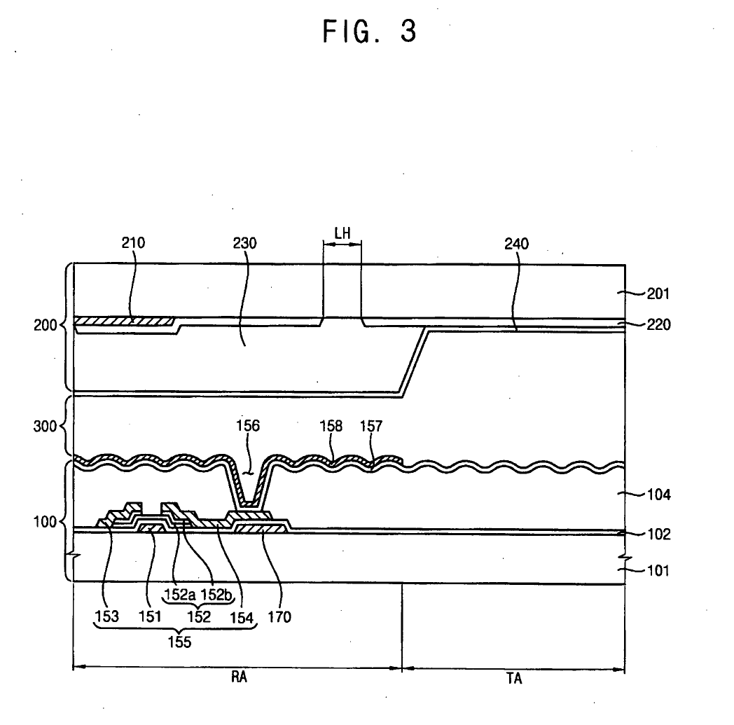

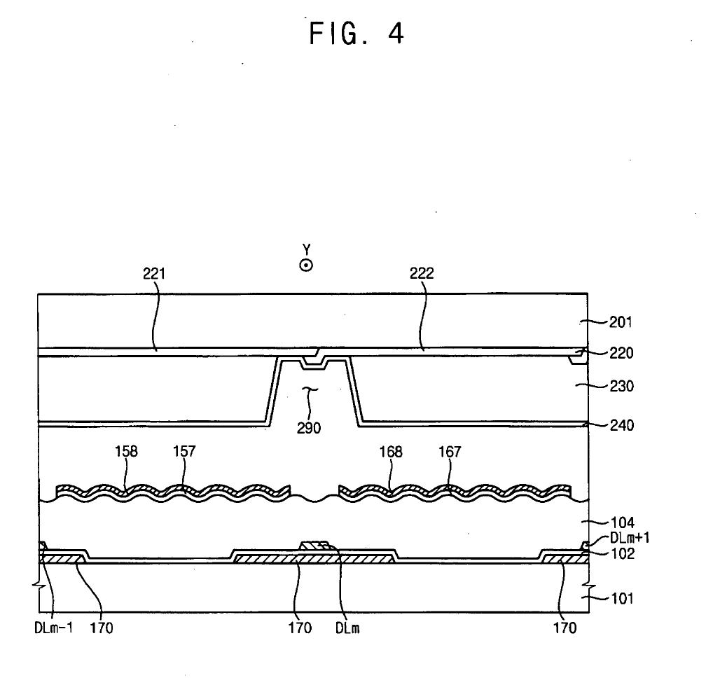

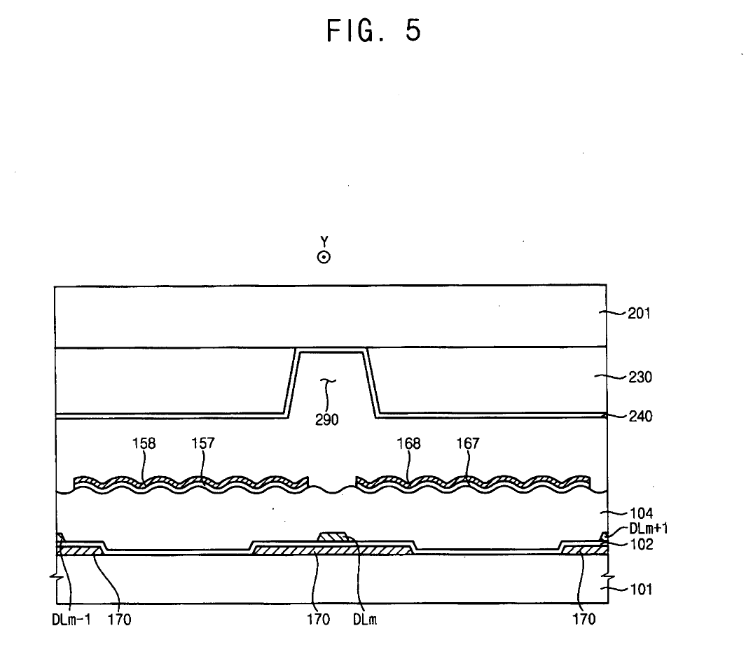

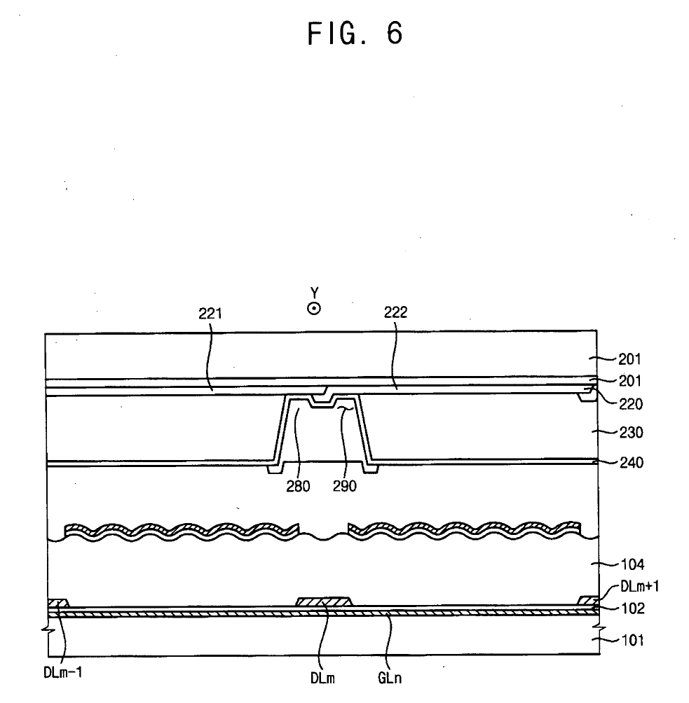

FIG. 2 is an enlarged plan view showing a portion of the reflective-transmissive LCD panel shown in FIG. 1. FIG. 3 is a cross-sectional view taken along a line I-I′ shown in FIG. 2. FIG. 4 is a cross-sectional view taken along a line II-II′ shown in FIG. 2. FIG. 5 is a cross-sectional view taken along a line III-III′ shown in FIG. 2. FIG. 6 is a cross-sectional view taken along a line IV-IV′ shown in FIG. 2.

Referring to FIGS. 2 to 6, the reflective-transmissive LCD panel includes a first pixel unit P1 and a second pixel unit P2.

The first pixel unit P1 is defined by source and gate lines DLm−1, DLm, GLn−1 and GLn adjacent to each other.

The first pixel unit P1 includes a first switching element 155 and a first pixel electrode 157. The first switching element 155 and the first pixel electrode 157 are located on the lower substrate. The first pixel electrode 157 is electrically connected to the first switching element 155. A first reflective electrode 158 is on the first pixel electrode 157, and the first reflective electrode 158 defines a transmissive region TA of the first pixel unit P1 and a reflective region RA of the first pixel unit P1.

The first pixel unit P1 may further include a first color filter pattern 221 which is on the upper substrate. The first pixel unit P1 displays a color light using the first color filter pattern 221 to display an image.

The second pixel part P2 is defined by source and gate lines DLm, DLm+1, GLn−1 and GLn adjacent to each other.

Second pixel unit P2 includes a second switching element 165 and a second pixel electrode 167. The second switching element 165 and the second pixel electrode 167 are on the lower substrate. The second pixel electrode 167 is electrically connected to the second switching element 165. A second reflective electrode 168 is on the second pixel electrode 167, and the second reflective electrode 168 defines a transmissive region TA of the second pixel unit P2 and a reflective region RA of the second pixel unit P2.

The second pixel unit P2 may further include a second color filter pattern 222 that is on the upper substrate. The second pixel unit P2 displays a color light using the second color filter pattern 222 to display an image.

A storage common line STL is formed in the first and second pixel units P1 and P2. The storage common line STL covers the source lines DLm−1, DLm and DLm+1.

Each of the first and second color filter patterns is partially removed to form a light hole LH corresponding to the reflective region RA of each of the first and second pixel units P1 and P2.

The light passes through the light hole LH to increase a luminance uniformity between the reflective region RA and the transmissive region TA. The light reflected from the reflective region RA passes through each of the first and second color filter patterns twice. However, the light passing through the transmissive region TA passes through each of the first and second color filter patterns once. When each of the first and second color filter patterns does not have the light hole LH, the luminance of the reflective region RA is smaller than that of the transmissive region TA. In FIGS. 1 to 6, each of the first and second color filter patterns has the light hole LH to increase the luminance of the reflective region RA so that the luminance of the reflective region RA may be substantially equal to the luminance of the transmissive region TA.

The openings 290 correspond to a portion of at least one source line DLm of the source lines DLm−1, DLm and DLm+1. In particular, a portion of the overcoat layer 230 corresponding to the source line DLm of the source lines DLm−1, DLm and DLm+1 is removed to form the openings 290. The overcoat layer 230 controls the cell-gaps of the reflective and transmissive regions RA and TA so that the cell-gap of the reflective region RA is a half of the cell-gap of the transmissive region TA. Each of the openings 290 has a groove shape that extends in the injection direction of the liquid crystal layer 300 so that the liquid crystals of the liquid crystal layer 300 may easily flow.

Referring to FIG. 3, the lower substrate 100 of the reflective-transmissive LCD panel includes a first base substrate 101.

Gate electrodes 151 and 161 of the first and second switching elements 155 and 165, and gate lines GLn−1 and GLn are formed on the first base substrate 101. The storage common line 170 may cover the source lines DLm−1, DLm and DLm+1 so that a portion of the black matrix on the upper substrate 200 corresponding to the source lines DLm−1, DLm and DLm+1 may be omitted.

A gate insulating layer 102 is on the gate electrodes and the gate lines GLn−1 and GLn. An amorphous silicon layer 152a of the first switching element 155 is on the gate insulating layer 102 corresponding to the gate electrode 151 of the first switching element 155, and an n+ amorphous silicon layer 152b of the first switching element 155 is on the amorphous silicon layer 152a. The n+ amorphous silicon layer 152b is doped in situ. The amorphous silicon layer 152a and the n+ amorphous silicon layer 152b form a channel layer 152 of the first switching element 155. A channel layer (not shown) of the second switching element 165 is on the gate insulating layer 102 corresponding to the gate electrode 161 of the second switching element 165.

Source electrodes 153 and 163 and drain electrodes 154 and 164 of the first and second switching elements 155 and 165 and the source lines DLm−1, DLm and DLm+1 are on the channel layer 152.

An organic layer 104 is on the source electrodes 153 and 163, the drain electrodes 154 and 164 and the source lines DLm−1, DLm and DLm+1. Alternatively, a passivation layer (not shown) may be on the source electrodes 153 and 163, the drain electrodes 154 and 164 and the source lines DLm−1, DLm and DLm+1, and the organic layer 104 may be on the passivation layer (not shown).

Contact holes 156 and 166 through which the drain electrodes 154 and 164 are partially exposed may be formed in the organic layer 104.

The pixel electrodes 157 and 167 corresponding to the first and second switching elements 155 and 165 are on the organic layer 104. Each of the pixel electrodes 157 and 167 may be on an entire area of each of the first and second pixel units P1 and P2. Alternatively, each of the pixel electrodes 157 and 167 may be on a portion of each of the first and second pixel units P1 and P2 corresponding to the transmissive region TA. The pixel electrodes 157 and 167 include a transparent conductive material. Examples of the transparent conductive material that can be used for the pixel electrodes 157 and 167 include indium tin oxide (ITO), and indium zinc oxide (IZO).

Reflective electrodes 158 and 168 are on the pixel electrodes 157 and 167, respectively. The reflective electrodes 158 and 168 may include highly reflective metal. Examples of the highly reflective metal that can be used for the reflective electrodes 158 and 168 include aluminum, and aluminum-neodymium.

A surface of the organic layer 104 may have an embossed pattern. The embossed pattern on the organic layer 104 corresponding to the transmissive region TA functions as a micro lens so that the internally provided light is scattered by the micro lens. The embossed pattern on the organic layer 104 corresponding to the reflective region RA functions as a reflective lens so that the externally provided light is scattered by the reflective lens. Alternatively, the organic layer 104 may have a flat surface.

The upper substrate 200 of the reflective-transmissive LCD panel includes a second base substrate 201.

The black matrix 210 is formed on the second base substrate 201. The black matrix 210 may correspond to the source lines DLm−1, DLm and DLm+1 and the gate lines GLn−1 and GLn.

Alternatively, the storage common line 170 that is under the source lines DLm−1, DLm and DLm+1 may cover the source lines DLm−1, DLm and DLm+1 so that the black matrix 210 may only correspond to the gate lines GLn−1 and GLn. In another embodiment, the black matrix 210 may only correspond to the source lines DLm−1, DLm and DLm+1.

The color filter layer 220 is on the second base substrate 201 having the black matrix 210. The color filter layer 220 is positioned above each of the first and second pixel units P1 and P2. The color filter layer 220 includes a red color filter pattern, a green color filter pattern and a blue color filter pattern.

A portion of the color filter layer 220 corresponding to the reflective region RA is partially removed to form the light hole LH.

The overcoat layer 230 is on the color filter layer 220 corresponding to the reflective region RA. The overcoat layer 230 controls the cell-gaps of the reflective region RA and the transmissive region TA so that the cell-gap of the transmissive region TA is about twice of the cell-gap of the reflective region RA. That is, a dual cell-gap is formed by the overcoat layer 230. When the overcoat layer 230 forms the dual cell-gap, the path length of the reflective region RA is substantially same as the transmissive region TA.

The common electrode layer 240 is on the overcoat layer 230.

A portion of the overcasting layer 230 corresponding to the source line DLm is removed to form the openings 290.

Each of the openings 290 has a groove shape that extends in the injection direction of the liquid crystal layer 300 so that the liquid crystals of the liquid crystal layer 300 may easily flow into the space between the upper and lower substrates. The injection direction is the Y-direction.

Each of the openings 290 corresponds to i.e. is positioned above a portion of the source lines DLm−1, DLm and DLm+1. For example, the openings 290 may correspond to source lines between a red pixel part and a green pixel part. Alternatively, the openings 290 may correspond to source lines between the green pixel element and a blue pixel element or between the blue pixel element and the red pixel element. The openings 290 may also correspond to the source lines between the red, green and blue pixel elements.

Each of the openings 290 has a greater width than each of the source lines DLm, and has a smaller width than the storage common line 170. For example, when the width of each of the source lines DLm is about 4 μm and the width of the storage common line is about 12 μm, the width of each of the openings 290 is about 6 μm to about 8 μm.

When the black matrix is formed on the upper substrate 200 corresponding to the source lines DLm, each of the openings 290 has a greater width than each of the source lines DLm, and has a smaller width than the black matrix.

That is, light that is distorted by the openings 290 is blocked by the storage common line 170 or the black matrix to improve an image display quality of the LCD panel.

Referring again to FIG. 6, when a portion of column spacers 280 corresponds to the openings 290, the column spacers 280 may be received in the openings 290 to guide the liquid crystals.

Although the portion of the column spacers 280 received in the openings 290 may not maintain the cell-gap between the lower and upper substrates 100 and 200, a remaining portion of the column spacers 280 that are not received in the openings 290 may maintain the cell-gap between the lower and upper substrates 100 and 200.

When an LCD device having the LCD panel is a portable LCD device, the LCD device includes low voltage driving liquid crystals to decrease a power consumption of the LCD device. A polarity and a viscosity of the low voltage driving liquid crystals are smaller than those of high voltage driving liquid crystals. When the viscosity of the liquid crystals is decreased, the liquid crystals may not be easily filled in the LCD panel, and an injection uniformity may be decreased.

In particular, an LCD panel having vertical alignment (VA) liquid crystals of low voltage employs a VA that has a large interference between liquid crystals and an alignment layer so that a filling efficiency is greatly reduced, thereby generating ‘not filling’ phenomena and defect in filling an outer area.

However, in FIGS. 1 to 6, the openings 290 that extend in the injection direction of the liquid crystals are formed on the overcoat layer 230 so that the liquid crystals are easily filled in the LCD panel to increase the injection uniformity of the liquid crystals.

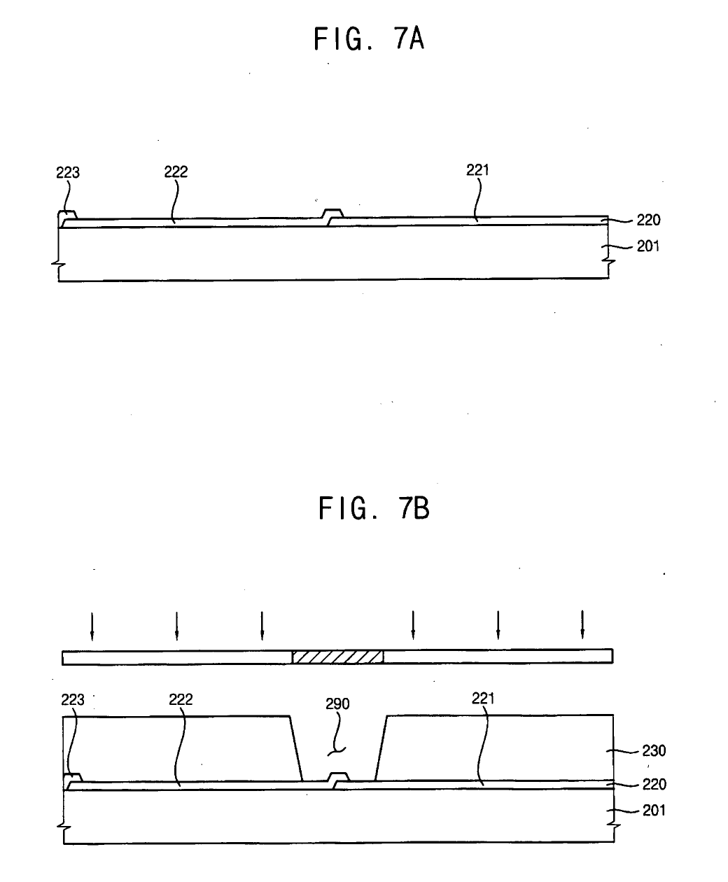

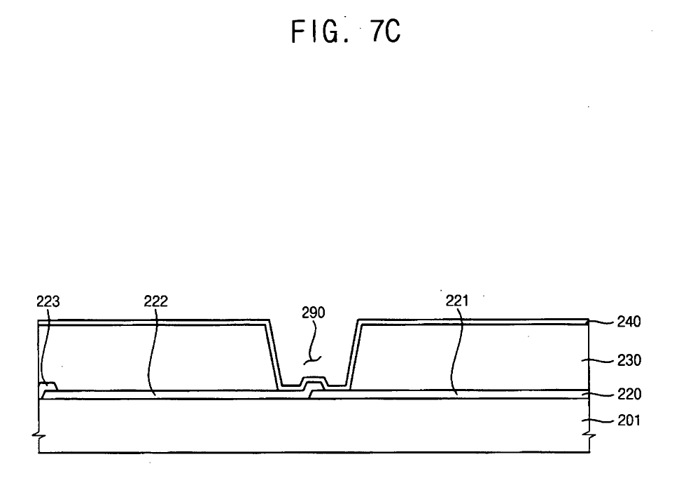

FIGS. 7A to 7C are cross-sectional views showing a method of manufacturing an upper substrate shown in FIGS. 4 and 5.

Referring to FIGS. 2, 3 and 7A, the upper substrate 200 includes the second base substrate 201. The second base substrate 201 includes a transparent glass substrate.

A photoresist layer for forming the color filter layer 220 is coated on the second base substrate 201. The photoresist layer is patterned to form the color filter layer 220. In particular, a red photoresist layer for forming the red color filter pattern 221 is coated and patterned to form the red color filter pattern 221. A green photoresist layer for forming the green color filter pattern 222 is coated and patterned to form the green color filter pattern 222. A blue photoresist layer for forming the blue color filter pattern 223 is coated and patterned to form the blue color filter pattern 223.

The color filter layer 220 corresponding to the reflective region RA of the lower substrate 100 is partially removed to form the light hole LH.

Alternatively, before the color filter layer 220 is formed, the black matrix may be formed on the second base substrate 201 corresponding to the source lines DLm−1, DLm and DLm+1 and the gate lines GLn−1 and GLn of the lower substrate 100.

Referring to FIGS. 2, 3 and 7B, the overcoat layer 230 is formed on the color filter layer 220. A mask is aligned on the second base substrate 201 having the overcoat layer 230. The overcoat layer 230 is exposed through the mask, and developed so that the overcoat layer 230 is partially removed to form the dual cell-gap and the openings 290.

In particular, the overcoat layer 230 corresponding to an entire of the transmissive region TA and a portion of the reflective region RA corresponding to the source line DLm is removed. That is, the overcoat layer 230 corresponding to the transmissive region TA is removed so that the dual cell-gap is formed between the transmissive and reflective regions TA and RA. In addition, the overcoat layer 230 corresponding to the source line DLm of the reflective region RA is partially removed to form the openings 290.

Each of the openings 290 has a groove shape that extends in the injection direction of the liquid crystals. The openings 290 guide the liquid crystals during an injection process so that the liquid crystals easily fill in the reflective-transmissive LCD panel.

Referring to FIG. 7C, the transparent conductive material is deposited on the second base substrate 201 having the overcoat layer 230 to form the common electrode layer 240. Examples of the transparent conductive material that can be used for the common electrode layer 240 include indium tin oxide (ITO), and indium zinc oxide (IZO).

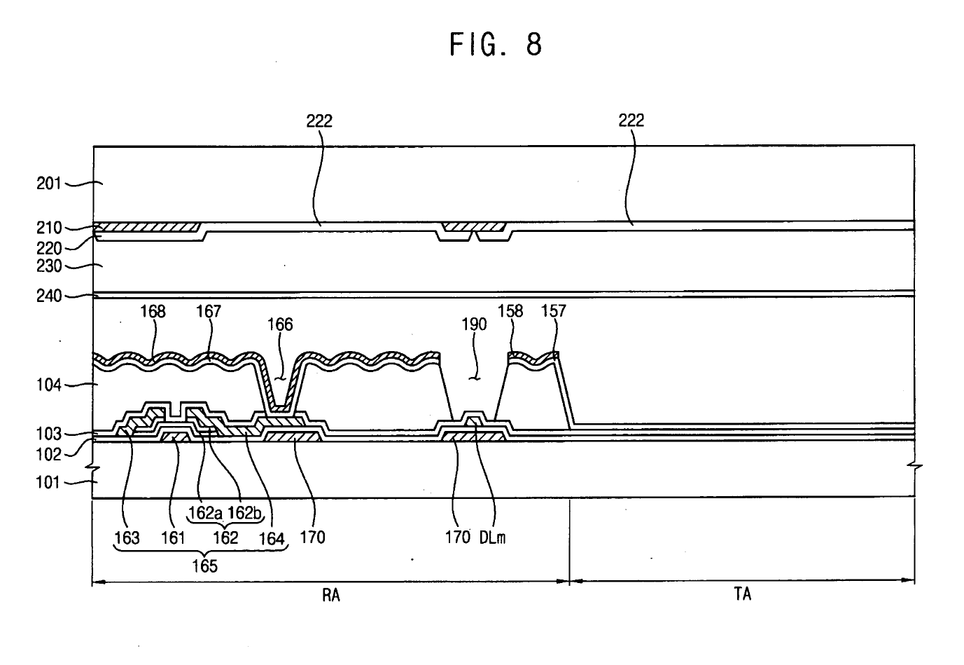

FIG. 8 is a cross-sectional view showing a reflective-transmissive LCD panel in accordance with another embodiment of the present invention. In many respects, the reflective-transmissive LCD panel of FIG. 8 is same as in FIGS. 1 to 7C except with the exception of the certain features of the overcoat layer, an organic layer and openings. Thus, the same reference numerals are used to refer to the same or like parts as those described in FIGS. 1 to 7C and any further explanation regarding them is not required.

Referring to FIGS. 2 and 8, a lower substrate 100 of the reflective-transmissive LCD panel includes a first base substrate 101.

Gate electrode 161 of switching elements 155 and 165, a storage common line 170, and gate lines GLn−1 and GLn are formed on a first base substrate 101. The storage common line 170 may cover source lines DLm−1, DLm and DLm+1 so that a portion of a black matrix of an upper substrate 200 corresponding to the source lines DLm−1, DLm and DLm+1 may be omitted.

Referring to FIG. 8, a gate insulating layer 102 is on the gate electrodes, the storage common line 170 and the gate lines GLn−1 and GLn. An amorphous silicon layer 162a of switching element 165 is on the gate insulating layer 102 corresponding to gate electrode 161, and an n+ amorphous silicon layer 162b of switching element 165 is on the amorphous silicon layer 162a. The n+ amorphous silicon layer 162b is doped in situ. The amorphous silicon layer 162a and the n+ amorphous silicon layer 162b form a channel layer 162 of the switching element 165. A channel layer (not shown) of another of the switching elements 155 and 165 is on the gate insulating layer 102 corresponding to another of the gate electrodes 151 and 161.

Source electrode 163 and drain electrode 164 of the first and second switching elements 165 and the source lines DLm−1, DLm and DLm+1 are on the channel layer 162.

A passivation layer 103 is on the source electrode 163, the drain electrode 164 and the source lines DLm−1, DLm and DLm+1. An organic layer 104 is on the passivation layer 103.

In FIG. 8, the organic layer 104 only corresponds to a reflective region RA. Contact holes 156 and 166 through which the drain electrodes 154 and 164 are partially exposed may be formed in the organic layer 104.

The organic layer 104 controls cell-gaps of the reflective region RA and a transmissive region TA so that the cell-gap of the transmissive region TA is about twice that of the cell-gap of the reflective region RA. That is, a dual cell-gap is formed by the organic layer 104. When the organic layer 104 forms the dual cell-gap, the path length of the reflective region RA is substantially same as the transmissive region TA.

A portion of the organic layer 104 corresponding to at least one source line DLm is removed to form the openings 190.

Each of the openings 190 is groove-shaped and extends in an injection direction of the liquid crystal layer so that liquid crystals of the liquid crystal layer may easily flow. The injection direction is a Y-direction.

Each of the openings 190 corresponds to a portion of the source lines DLm−1, DLm and DLm+1. For example, the openings 190 may correspond to source lines between a red pixel element and a green pixel element. Alternatively, the openings 190 may correspond to source lines between the green pixel element and a blue pixel element or between the blue pixel element and the red pixel element. The openings 190 may also correspond to the source lines between the red, green and blue pixel parts.

Each of the openings 190 has a greater width than each of the source lines DLm, and has a smaller width than the storage common line 170. For example, when the width of each of the source lines DLm is about 4 μm and the width of the storage common line 170 is about 12 μm, the width of each of the openings 190 is about 6 μm to about 8 μm.

Alternatively, each of the openings 190 may have a greater width than each of the source lines DLm, and has a smaller width than the black matrix 210 of the upper substrate 200.

That is, a light that is distorted by the openings 190 is blocked by the storage common line 170 or the black matrix 210 to improve an image display quality of the LCD panel.

Pixel electrodes 157 and 167 are on the organic layer 104 having the contact holes 156 and 166. Each of the pixel electrodes 157 and 167 may be on an entire of a pixel part. Alternatively, each of the pixel electrodes 157 and 167 may be on a portion of each of the pixel parts corresponding to the transmissive region TA. The pixel electrodes 157 and 167 include a transparent conductive material. Examples of the transparent conductive material that can be used for the pixel electrodes 157 and 167 include indium tin oxide (ITO), and indium zinc oxide (IZO).

Reflective electrodes 158 and 168 are on the pixel electrodes 157 and 167, respectively. The reflective electrodes 158 and 168 may include highly reflective metal. Examples of the highly reflective metal that can be used for the reflective electrodes 158 and 168 include aluminum, and aluminum-neodymium.

A surface of the organic layer 104 may have an embossed pattern. The embossed pattern on the organic layer 104 corresponding to the transmissive region TA functions as a micro lens so that the internally provided light is scattered by the micro lens. The embossed pattern on the organic layer 104 corresponding to the reflective region RA functions as a reflective lens so that the externally provided light is scattered by the reflective lens. Alternatively, the organic layer 104 may have a flat surface.

The upper substrate 200 of the reflective-transmissive LCD panel includes a second base substrate 201.

The black matrix 210 is formed on the second base substrate 201. The black matrix 210 may correspond to the source lines DLm−1, DLm and DLm+1 and the gate lines GLn−1 and GLn.

Alternatively, the storage common line 170 that is under the source lines DLm−1, DLm and DLm+1 may cover the source lines DLm−1, DLm and DLm+1 so that the black matrix 210 may only correspond to the gate lines GLn−1 and GLn. In another embodiment, the black matrix 210 may only correspond to the source lines DLm−1, DLm and DLm+1.

The color filter layer 220 is on the second base substrate 201 having the black matrix 210. The color filter layer 220 corresponds to the pixel unit. The color filter layer 220 includes a red color filter pattern, a green color filter pattern and a blue color filter pattern.

A portion of the color filter layer 220 corresponding to the reflective region RA is partially removed to form the light hole LH. [Need to add FIG. 8 light hole LH.] The overcoat layer 230 is on the color filter layer 220. The overcoat layer 230 may be on the reflective region RA and the transmissive region TA. The common electrode layer 240 is on the overcoat layer 230.

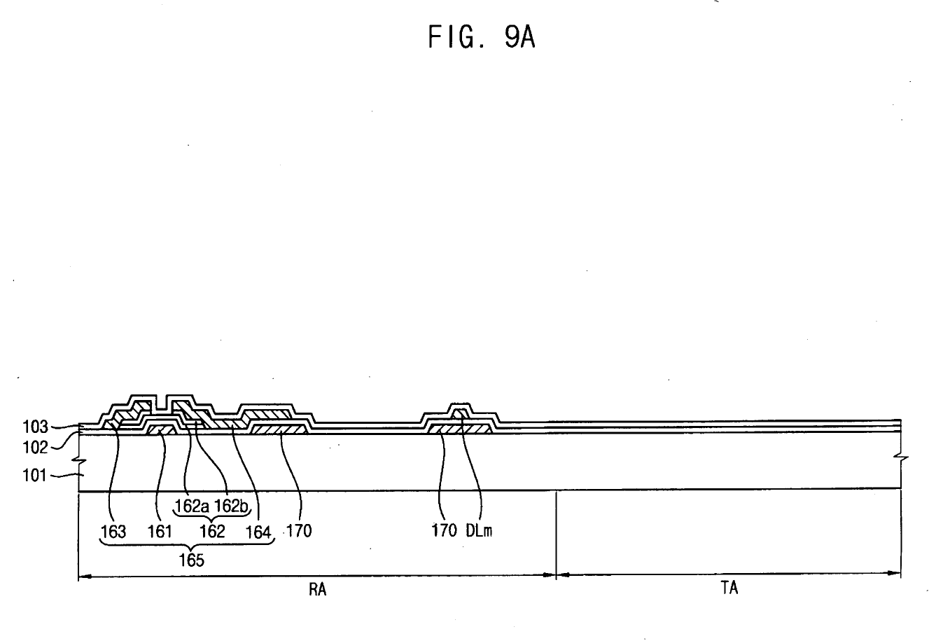

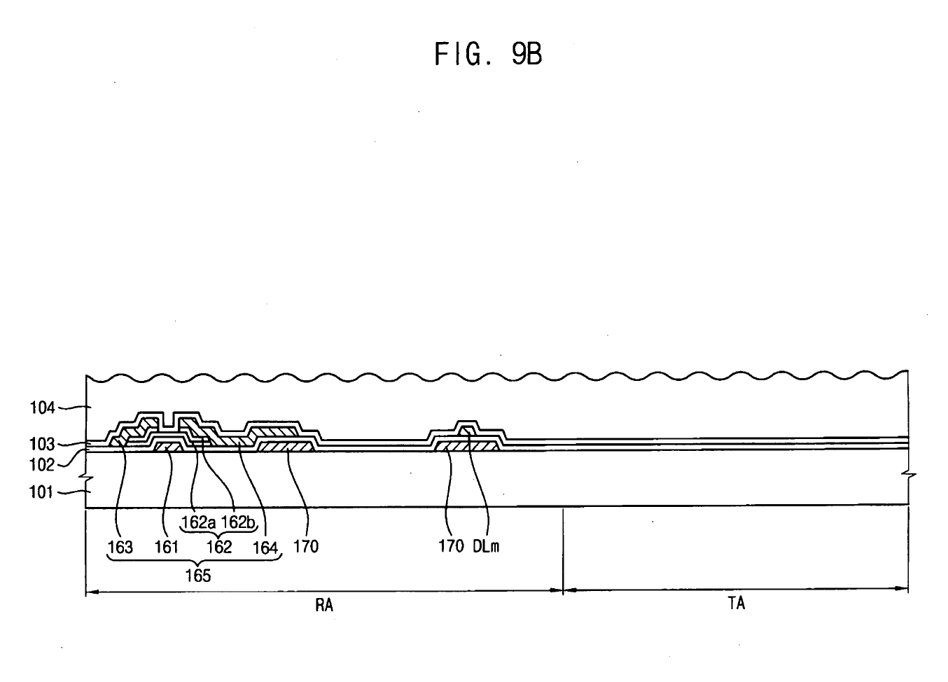

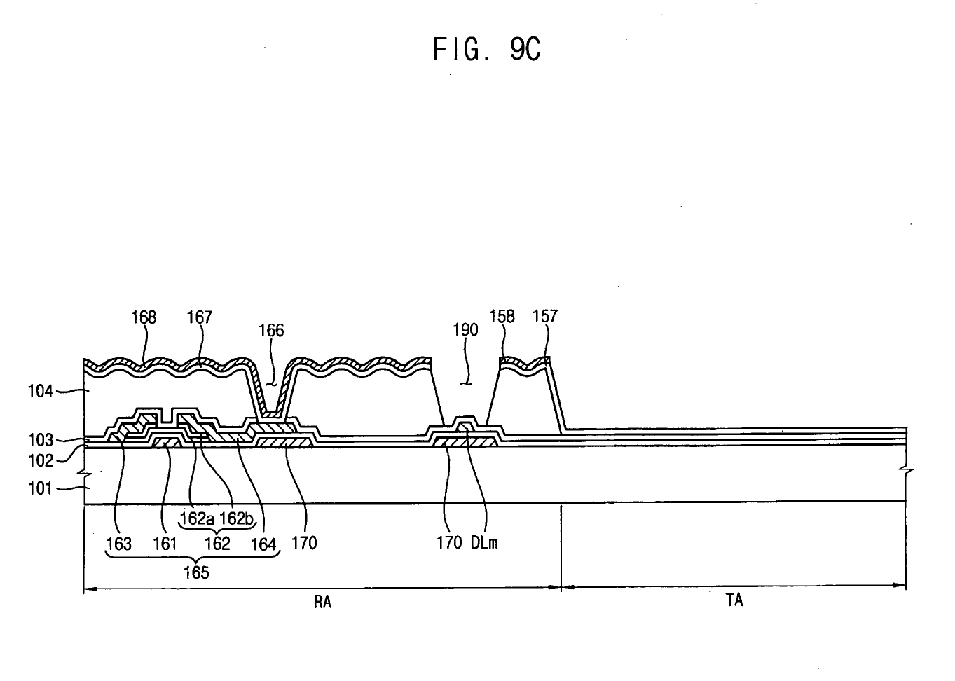

FIGS. 9A to 9C are cross-sectional views showing a method of manufacturing a lower substrate shown in FIG. 8.

Referring to FIGS. 2 and 9A, the source lines DLm−1, DLm and DLm+1, the gate lines GLn−1 and GLn, the first and second switching elements 155 and 165, and the storage common line 170 are formed on the first base substrate 101.

The passivation layer 103 is formed on the first base substrate 101 having the source electrodes 153 and 163, the drain electrodes 154 and 164 and the source lines DLm−1, DLm and DLm+1.

Referring to FIGS. 2, 9B and 9C, the organic layer 104 is formed on the first base substrate 101 having the passivation layer 103, and the organic layer 104 is partially removed to form the dual cell-gap and the openings 190.

In particular, the organic layer 104 corresponding to an entire of the transmissive region TA and a portion of the reflective region RA corresponding to the source line DLm is removed. That is, the organic layer 104 corresponding to the transmissive region TA is removed so that the dual cell-gap is formed between the transmissive and reflective regions TA and RA.

In addition, the organic layer 104 corresponding to the at least one source line DLm of the source lines DLm−1, DLm and DLm+1 in the reflective region RA is partially removed to form the openings 190. That is, each of the openings 190 has a groove shape that extends in the injection direction of the liquid crystals. The openings 190 guide the liquid crystals during an injection process so that the liquid crystals are easily filled in the reflective-transmissive LCD panel.

In addition, a portion of the organic layer 104 corresponding to the drain electrodes 154 and 164 is partially removed to form the contact holes 156 and 166.

The transparent conductive material is deposited on the organic layer 104 to form the pixel electrodes 157 and 167. Each of the pixel electrodes 157 and 167 may be on an entire of the pixel part. Alternatively, each of the pixel electrodes 157 and 167 may be on a portion of the pixel part corresponding to the transmissive region TA. The pixel electrodes 157 and 167 include a transparent conductive material. Examples of the transparent conductive material that can be used for the pixel electrodes 157 and 167 include indium tin oxide (ITO), and indium zinc oxide (IZO).

A highly reflective metal layer is deposited on the pixel electrodes 157 and 167, and the highly reflective metal layer is patterned to form reflective electrodes 158 and 168. Examples of the highly reflective metal that can be used for the reflective electrodes 158 and 168 include aluminum, and aluminum-neodymium.

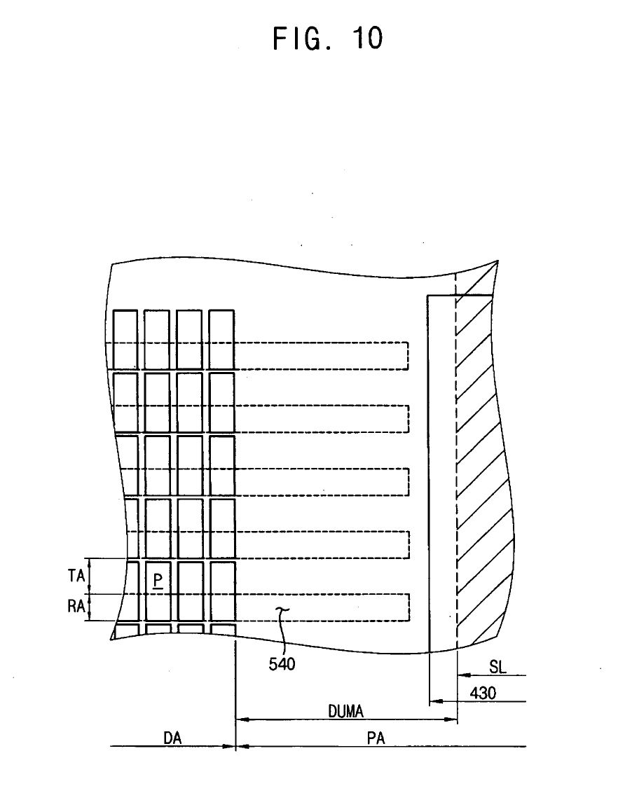

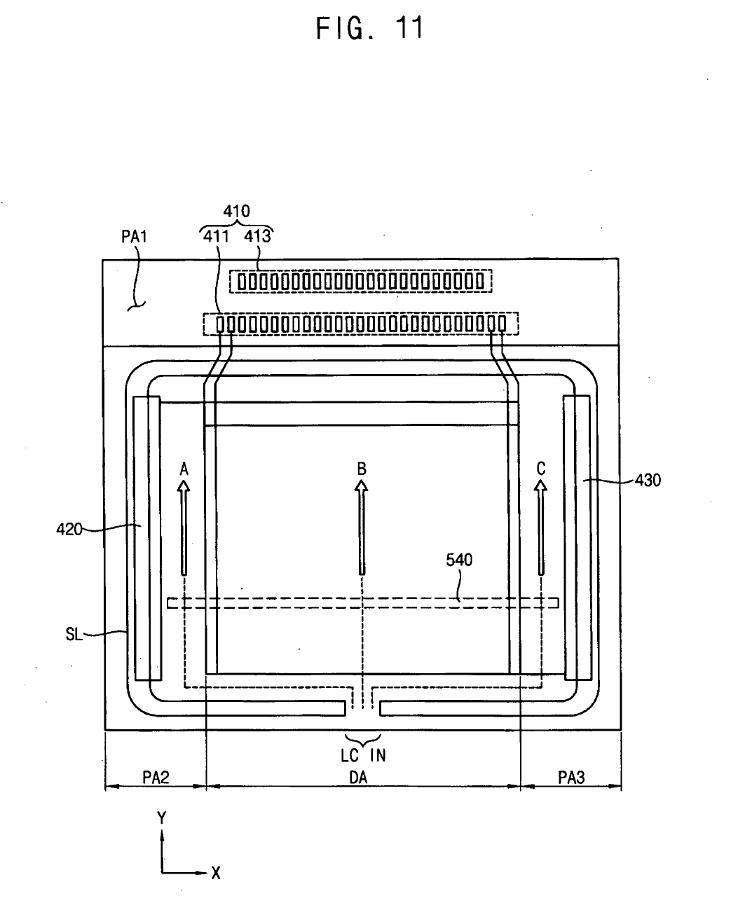

FIG. 10 is a plan view showing a reflective-transmissive LCD panel in accordance with another embodiment of the present invention.

Referring to FIG. 10, the reflective-transmissive LCD panel includes a display region DA and a peripheral region PA. A plurality of pixel units P is included in the display region DA. The peripheral region PA surrounds the display region DA. The peripheral region PA includes a dummy region DUMA, a seal-line region SL and a gate circuit region. The dummy region DUMA is adjacent to the display region DA. A sealing member is in the seal-line region SL. A gate circuit 430 is in the gate circuit region.

Each of the pixel units P that are in the display region DA includes a reflective region RA and a transmissive region TA. A reflective electrode is included in the reflective region RA. The reflective electrode is not formed in the transmissive region TA.

Each of the pixel units P includes an insulating layer 540 so that the reflective region RA has a different cell-gap from the transmissive region TA.

In particular, the insulating layer 540 may be an overcoat layer 240 shown in FIG. 3 that is formed on the upper substrate 200 corresponding to the reflective region RA. Alternatively, the insulating layer 540 may be an organic layer 104 as shown in FIG. 8 that is formed on the lower substrate 100 corresponding to the reflective region RA.

The insulating layer 540 may be in the display region DA and the dummy region DUMA. The insulating layer 540 may be on an entire of the dummy region DUMA or a portion of the dummy region DUMA. For example, the insulating layer 540 extends toward the peripheral region PA in which a dummy column spacer is formed.

When the insulating layer 540 is only in the display region DA, an injection speed of liquid crystals in the display region DA is faster than that of liquid crystals in the peripheral region PA so that an injection uniformity of the liquid crystals is decreased.

In FIG. 10, the insulating layer 540 extends from the display region DA toward the peripheral region PA so that the injection speed of the liquid crystals in the display region DA is faster than that of the liquid crystals in the peripheral region PA to increase the injection uniformity.

FIG. 11 is a plan view showing a liquid crystal injected into the reflective-transmissive LCD panel shown in FIG. 10.

Referring to FIG. 11, a liquid crystal injection portion LC IN is formed on an opposite side of connector 410 of the reflective-transmissive LCD panel. Connector 410 includes a first pad portion 411 and a second pad portion 412. A flexible printed circuit board is on the first pad portion 411. A driving chip is on the second pad portion 412.

The liquid crystals injected through the liquid crystal injection port LC IN flow a first filling direction A, a second filling direction B and a third filling direction C. The first filling direction A is an injection direction of the liquid crystals in a second peripheral region PA2 corresponding to a first gate circuit 420. The second filling direction B is an injection direction of the liquid crystals in the display region DA corresponding to a central part 430. The third filling direction C is an injection direction of the liquid crystals in a third peripheral region PA3.

The reflective-transmissive LCD panel includes an insulating layer 540 to form a dual cell-gap. The insulating layer 540 may extend from the display region DA toward the second and third peripheral regions PA2 and PA3 by a predetermined distance.

The liquid crystals in the first, second and third filling directions A, B and C have a substantially same filling speed.

The insulating layer 540 may be an overcoat layer of an upper substrate or an organic layer of a lower substrate. The insulating layer 540 may include openings having a groove shape that extend in each of the first, second and third filling directions A, B and C.

In FIG. 11, the insulating layer 540 extends from the display region DA toward the second and third peripheral regions PA2 and PA3 so that the liquid crystals are filled in the reflective-transmissive LCD panel at a constant speed, thereby increasing the injection speed. Therefore, the liquid crystals may fully fill in the reflective-transmissive LCD panel.

According to the present invention, the insulating layer for forming the dual cell gap includes the openings that extend in the injection direction of the liquid crystals so that the liquid crystals are easily filled in the LCD device.

In addition, the insulating layer extends toward the peripheral region to increase the injection speed and the injection uniformity of the liquid crystals. Therefore, the manufacturing cost of the LCD device is decreased, and the image display quality of the LCD device is improved.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display substrate comprising:
a substrate including a plurality of pixel elements which define a plurality of pixel units, each of the pixel units including a transparent portion through which light from a first source passes and a reflective portion from which light from a second source is reflected; and
an overcoat layer positioned on the substrate, the overcoat layer including an opening between adjacent pixel elements of adjacent pixels, wherein the overcoat layer is positioned to correspond to the reflective portions.

2. The display substrate of claim 1, further comprising a transparent electrode layer on the overcoat layer.

3. The display substrate of claim 1, wherein the overcoat layer extends in a first direction and wherein the opening in the overcoat layer extends in a second direction across the overcoat layer.

4. The display substrate of claim 1, further comprising a color filter layer on each of the pixel elements.

5. The display substrate of claim 4, wherein the color filter layer includes an aperture which corresponds to the reflective portion.

6. The display substrate of claim 1, further comprising a black matrix that blocks a portion of the first and second lights.

7. The display substrate of claim 6, wherein the opening has a smaller width than the black matrix.

8. The display substrate of claim 1, wherein the substrate is divided into a display region in which the pixel elements are formed and a peripheral region that surrounds the display region, and further wherein the overcoat layer is included in the display region and the peripheral region.

9. The display substrate of claim 8, wherein the peripheral region comprises a dummy region that surrounds the display region and a seal line region that surrounds the dummy region and the overcoat layer is included in the display region and the dummy region.

10. A display substrate comprising:
a substrate including:
a plurality of pixel elements which define a plurality of pixel units, each of the pixel units being positioned in an area defined by source and gate lines;
a switching element associated with each of the pixel units;
an organic layer in a portion of each of the pixel units along the gate lines, the organic layer including a plurality of openings extending to a portion of the source lines;
a pixel electrode electrically connected to the switching element, wherein the pixel electrode is included in each of the pixel units and transmits light from a first source; and
a reflective electrode on the organic layer, the reflective electrode defining a reflective portion in each of the pixel units, wherein light from a second source is reflected from the reflective electrode.

11. The display substrate of claim 10, further comprising a storage common line that covers the source lines.

12. The display substrate of claim 11, wherein each of the openings has a smaller width than the storage common line.

13. The display substrate of claim 11, wherein each of the openings has a greater width than the source line.

14. The display substrate of claim 11, wherein the substrate is divided into a display region in which the pixel units are formed and a peripheral region that surrounds the display region, and further wherein the overcoat layer is included in the display region and in the peripheral region.

15. The display substrate of claim 14, wherein the peripheral region comprises a dummy region that surrounds the display region and a seal line region that surrounds the dummy region and the overcoat layer is included in the display region and the dummy region.

16. A liquid crystal display panel comprising:
a first substrate including a plurality of source lines, a plurality of gate lines and a plurality of pixel units, each of the pixel units having a transmissive portion and a reflective portion;
a second substrate including an overcoat layer corresponding to the reflective portion, the overcoat layer having a plurality of openings corresponding to a portion of the source lines; and
a liquid crystal layer interposed between the first and second substrates, the liquid crystal layer having a first cell-gap associated with the transmissive portion and a second cell-gap associated with the reflective portion that has the overcoat layer.

17. The liquid crystal display panel of claim 16, wherein the first substrate further comprises a storage common line that covers the source lines.

18. The liquid crystal display panel of claim 17, wherein each of the openings has a smaller width than the storage common line.

19. The liquid crystal display panel of claim 16, wherein the second substrate comprises a black matrix that defines internal spaces corresponding to the pixel parts, and each of the openings has a greater width than the black matrix.

20. A liquid crystal display panel comprising:
a display substrate including:
a display region having a plurality of pixel units which include a transmissive portion and a reflective portion; and
a peripheral region surrounding the display region;
an insulating layer corresponding to the reflective portion and a portion of the peripheral region; and
a liquid crystal layer having a first cell-gap associated with the transmissive portion and a second cell-gap associated with the reflective portion that has the insulating layer.

21. The liquid crystal display panel of claim 20, wherein the display substrate comprises a plurality of source lines and a plurality of gate lines, and wherein the insulating layer extends substantially in parallel with the gate lines and further wherein the insulating layer includes a plurality of openings.

22. The liquid crystal display panel of claim 20, wherein the display substrate further comprises a storage common line that covers the source lines and each of the openings has a smaller width than the storage common line.
